(19) United States
(12) Patent Application Publication
(10) Pub. No.: US 2005/0154800 A1
(43) Pub. Date: Jul. 14, 2005

(54) Command serialization

(76) Inventors: Ofir Zohar, Alfe-Menashe (IL); Yaron Revah, Tel-Aviv (IL); Haim Helman, Ramat Gan (IL); Dror Cohen, Petach-Tikva (IL); Shemer Schwartz, Herzelia (IL); Efraim Zeidner, Kiryat Motzkin (IL)

Correspondence Address: KATTEN MUCHIN ROSENMAN LLP, 575 MADISON AVENUE, NEW YORK, NY, 10022-2585, US

(21) Appl. No.: 10/756,952

(22) Filed: Jan. 13, 2004

(51) Int. Cl. G06F 3/00

(52) U.S. Cl. 710/5

(57) ABSTRACT

A method for conveying a Small Computer System Interface (SCSI) command from a host to a logical volume, the method consisting of incorporating an indication of an address of the logical volume in the SCSI command so as to generate a modified SCSI command. The method further includes conveying the modified SCSI command from the host to a target device, receiving the modified SCSI command at the target device and recovering the address from the modified SCSI command. In response to the recovered address, the SCSI command is executed at the logical volume.

### FIELD OF THE INVENTION

The present invention relates generally to managing computer system commands, and particularly to managing storage commands placed in parallel to large numbers of devices in a storage system.

### BACKGROUND OF THE INVENTION

The Small Computer System Interface (SCSI) system comprises a number of protocols, the most recent a SCSI-3 protocol, which is published by the International Committee for Information Technology Standards (INCITS), Washington, D.C. Documents SCSI-3 Primary Commands (SPC), reference number ANSI/INCITS 301-1997, and SCSI Stream Commands-2, reference number ANSI/INCITS 380-2003, which are incorporated herein by reference, describe commands used by the protocol.

SCSI protocols operate according to a command/response routine, wherein an initiator conveys a command to a target, and the target sends or receives data and, upon completion of the operation, acknowledges the command with a response to the initiator. The SCSI-3 protocol enables multiple targets to be coupled to each initiator, by a SCSI bus or other SCSI compatible connection. In the SCSI-3 protocol each target in turn may comprise many logical units (LUs), so that each LU in a SCSI system may be considered to be fully represented by a (target, LU) pair. In order for a particular initiator to communicate with a specific LU, the initiator generates a driver specific to the (target, LU) pair. Thus, one initiator may in fact be coupled to a large number of logical units, by generating a corresponding number of drivers.

The initiator may issue commands to any of the LUs to which it is coupled, via the drivers. Typically, commands to the LUs are issued by an application level program running on the initiator. Each command is then transferred from the initiator to the LU wherein the command is fulfilled, and a message (the response) is returned from the LU to the application, via the initiator, to indicate the fulfillment. The message, when received by the application, indicates that the command has completed.

The SCSI-3 protocol includes a Command Descriptor Block (CDB) for transferring a command issued by the application level program. The CDB comprises a local block address (LBA) field which is defined in the documents referenced above as the address on an LU or within a volume partition, the latter being defined as a logical volume within [a] single physical volume. In order to implement the command, the CDB is transferred to the LU or the volume partition, and the command is executed at the LBA of the LU or the volume partition. Hereinbelow, in the specification and in the claims, an LU or a volume partition is referred to as a logical volume or volume, so that the LBA field is an address in the volume.

More than one command per logical volume may be in progress at any particular time, since the issuing of a command by the application, and the steps following issuance until completion of the command, are substantially independent. In order to manage the multiplicity of commands that may thus be issued, one of two methods is typically used. In a polling method, which is typically adopted in SCSI systems and which is relatively easy to implement, the application continually polls the drivers of the initiator to check if a command to a specific volume has completed. In an interrupt method, which may alternatively be used in a SCSI system, each time a driver of the initiator receives a completion message from an volume, it sends a call to the application. However, this latter method raises very complex problems of implementation and it is thus seldom followed.

In SCSI systems where large numbers of (target, volume) pairs exist, both approaches are difficult to manage, and the difficulty increases as the number of pairs increases. A method which bypasses the difficulties inherent in both approaches would thus be advantageous.

### SUMMARY OF THE INVENTION

It is an object of some aspects of the present invention to provide a method and apparatus for conveying a Small Computer System Interface (SCSI) command.

In preferred embodiments of the present invention, a host and a plurality of logical volumes operate according to a SCSI protocol known in the art, most preferably a SCSI-3 protocol. The host is able to operate as an initiator, and the volumes are able to be addressed by the host. In order to convey a SCSI command from the host to a specific volume, the host incorporates an indication of an address of the volume to which the SCSI command is directed into the command, thereby forming a modified SCSI command. The modified SCSI command is transmitted to a device server in one of the volumes, via a device object that is resident at the host. The device server receives the modified SCSI command, and recovers from it the volume address and the SCSI command, which the device server directs to the specific volume.

The host and the plurality of volumes are typically in a SCSI environment having one or more hosts and a large number of volumes. The use of modified SCSI commands enables the volumes to be grouped into a smaller number of pluralities of volumes, each plurality, herein termed a target, having a respective device server in one of the volumes of the target. Each host only needs to maintain one device object for each device server, since the modified SCSI command is transferred from the device object to the device server. Each device server directs the recovered SCSI command to the correct volume within its target.

By modifying the SCSI commands to include an indication of the volume address to which the command is directed, each host only needs to maintain a relatively small number of device objects, compared to prior art SCSI systems, thus significantly reducing required management sources.

Most preferably, each host is configured with an interface object, typically a file or a pseudo-file, which tracks the commands. An application running on the host polls the interface object to both initiate commands and to determine if the commands have been executed. Polling of the interface object replaces the need of the host to poll and/or track each device object comprised in the host individually, and further reduces the management resources required to operate the host.

There is therefore provided, according to a preferred embodiment of the present invention, a method for conveying a Small Computer System Interface (SCSI) command from a host to a logical volume, the method including:

incorporating an indication of an address of the logical volume in the SCSI command so as to generate a modified SCSI command;

conveying the modified SCSI command from the host to a target device;

receiving the modified SCSI command at the target device and recovering the address from the modified SCSI command; and

executing the SCSI command at the logical volume in response to the recovered address.

The logical volume preferably includes at least one of a volume partition and a logical unit, and the indication preferably includes the address of the logical volume.

Preferably, the logical volume is included in a plurality of logical volumes, and the target device is included in the plurality.

Receiving the modified SCSI command at the target device preferably includes converting the modified SCSI command to the SCSI command and conveying the SCSI command to the logical volume in response to the recovered address.

Preferably, the SCSI command includes a logical block address (LBA) in the logical volume.

There is further provided, according to a preferred embodiment of the present invention, a method for accessing data, including:

generating in a host an interface object;

generating in the host a first plurality of device objects adapted to convey a data command from the host to a second plurality of logical volumes;

writing in the interface object from an application one or more indications of addresses of the logical volumes, the one or more indications comprising a target-indication of an address of a targeted logical volume;

designating one of the device objects to convey the data command to the targeted logical volume in response to the target-indication in the interface object; and

accessing the data in the targeted logical volume in response to the data command.

Designating the one of the device objects preferably includes:

opening a connection between the one of the device objects and the targeted logical volume; and

conveying the data command via the connection.

Further preferably, the method includes writing an indication of the connection in the interface object.

The interface object preferably includes at least one of a file and a pseudo-file.

Preferably, accessing the data includes one of reading the data from the targeted logical volume and writing the data to the targeted logical volume.

The method preferably further includes:

performing an execution of the data command at the targeted volume; and

removing the target-indication from the interface object in response to the execution.

Writing in the interface object preferably includes the application polling the interface object to perform the writing, and the application polling the interface object preferably includes the application removing the target-indication from the interface object in response to an execution of the data command at the targeted volume.

Preferably, the host and the logical volumes operate according to a Small Computer System Interface (SCSI) protocol.

Further preferably the data command includes a SCSI command, and the method further includes:

incorporating the target-indication in the SCSI command so as to generate a modified SCSI command;

conveying the modified SCSI command from the host to a target device;

receiving the modified SCSI command at the target device and recovering the address from the modified SCSI command; and

executing the SCSI command at the targeted logical volume in response to the recovered address.

There is further provided, according to a preferred embodiment of the present invention, apparatus for conveying a Small Computer System Interface (SCSI) command from a host to a logical volume, the apparatus including:

a processor which is adapted to:

incorporate an indication of an address of the logical volume in the SCSI command so as to generate a modified SCSI command, and

convey the modified SCSI command from the host; and

a target device which is adapted to:

receive the modified SCSI command at the target device and recover the address from the modified SCSI command, and

convey the SCSI command to the logical volume, for execution therein, in response to the recovered address.

Preferably, the logical volume includes at least one of a volume partition and a logical unit, and the indication includes the address of the logical volume.

Preferably, the logical volume is included in a plurality of logical volumes, and the target device is included in the plurality.

The target device is preferably adapted to convert the modified SCSI command to the SCSI command.

Preferably, the SCSI command includes a logical block address (LBA) in the logical volume.

There is further provided, according to a preferred embodiment of the present invention, apparatus for accessing data, including:

a targeted logical volume which is adapted to access the data in response to a data command; and

a host consisting of:

an interface object;

a first plurality of device objects adapted to convey the data command from the host to a second plurality of logical volumes; and

a processor which is adapted to:

write in the interface object from an application one or more indications of addresses of the logical volumes, the one or more indications including a target-indication of an address of the targeted logical volume, and

designate one of the device objects to convey the data command to the targeted logical volume in response to the target-indication in the interface object.

Preferably, designating the one of the device objects includes:

opening a connection between the one of the device objects and the targeted logical volume; and

conveying the data command via the connection.

The processor is preferably adapted to write an indication of the connection in the interface object, and the interface object includes at least one of a file and a pseudo-file.

Further preferably, accessing the data includes one of reading the data from the targeted logical volume and writing the data to the targeted logical volume.

The targeted logical volume is preferably adapted to perform an execution of the data command thereat, and the processor is preferably adapted to remove the target-indication from the interface object in response to the execution.

Preferably, writing in the interface object includes the application polling the interface object to perform the writing, and the application polling the interface object includes the application removing the target-indication from the interface object in response to an execution of the data command at the targeted volume.

Preferably, the host and the logical volumes operate according to a Small Computer System Interface (SCSI) protocol.

The data command preferably includes a SCSI command, and the processor is adapted to:

incorporate the target-indication in the SCSI command so as to generate a modified SCSI command,

convey the modified SCSI command from the host;

and the apparatus preferably further includes:

a target device which is adapted to receive the modified SCSI command and recover the address from the modified SCSI command and convey the SCSI command to the targeted logical volume, for execution therein, in response to the recovered address.

The present invention will be more fully understood from the following detailed description of the preferred embodiments thereof, taken together with the drawings, a brief description of which follows.

### BRIEF DESCRIPTION OF THE DRAWINGS

FIG. 1 is a schematic block diagram of a storage arrangement, according to a preferred embodiment of the present invention;

FIG. 2 is a schematic block diagram of an initiator of the arrangement of FIG. 1, coupled to logical volumes of the arrangement, according to a preferred embodiment of the present invention;

FIG. 3 is a schematic diagram illustrating a command structure, according to a preferred embodiment of the present invention;

FIG. 4 is a schematic representation of a file generated by a module of the initiator of FIG. 2, according to a preferred embodiment of the present invention; and

FIG. 5 is a flowchart showing steps involved in transmission of a command according to the command structure of FIG. 3, according to a preferred embodiment of the present invention.

### DETAILED DESCRIPTION OF PREFERRED EMBODIMENTS

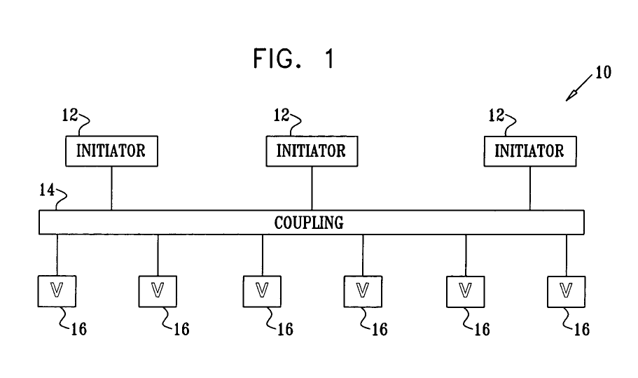

Reference is now made to FIG. 1, which is a schematic block diagram of a storage arrangement 10, according to a preferred embodiment of the present invention. Arrangement 10 comprises one or more host computers 12 which are coupled by a coupling 14 to a plurality of peripheral logical entities 16. Each logical entity 16 comprises a logical unit which is addressable by a respective logical unit number (LUN), or a volume partition which is addressable. In the specification and in the claims, the terms logical volume and volume are to be understood as comprising a logical unit or a volume partition. Entities 16 are referred to hereinbelow as volumes 16, and specific volumes comprised in volumes 16 are also referred to hereinbelow as Va, Vb, Vc, . . . . Coupling 14 typically comprises a bus, although it will be understood that coupling 14 may comprise other suitable methods for coupling host computers 12 to volumes 16, such as fibre channel, and wired or wireless coupling. Arrangement 10 is configured to operate generally according to a Small Computer System Interface (SCSI) protocol, such as one of the protocols referred to in the Background of the Invention, except for modifications to the protocol described hereinbelow. The modified SCSI protocol under which arrangement 10 operates is referred to hereinbelow as the mod-SCSI protocol.

Host computers 12 are assumed to be able to operate as initiators, and are also referred to as initiators hereinbelow; each volume 16 is assumed to be able to be addressed by initiators 12, as described in more detail below. By way of example, initiators 12 are assumed to operate under a Linux operating system, available at www.linux.org, although any other suitable operating system may be used.

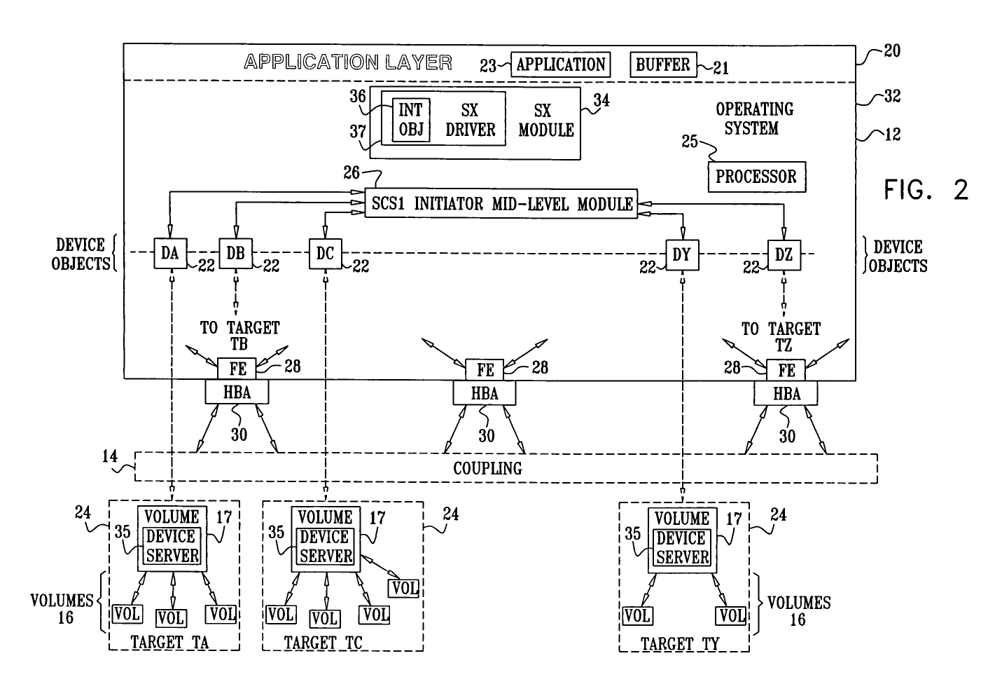

FIG. 2 is a schematic block diagram of one of initiators 12. coupled to volumes 16, according to a preferred embodiment of the present invention. Initiator 12 comprises a processor 25 which operates one or more applications, herein assumed to comprise an application 23 running within an application layer 20, which communicate with an operating system 32 run by the processor. Operating system 32 comprises a SCSI initiator mid-level (SIML) module 26, typically a Linux module driver scsi_mod_o, which functions to define internal interfaces and provide common services to front end (FE) modules 28 of varying types, as are known in the art, such as an FE module for Internet SCSI (iSCSI) targets, an FE module for Fibre Channel (FC) targets, and/or an FE module for a parallel SCSI bus. Each FE module 28 is coupled to a host bus adapter (HBA) 30, typically a network cartridge, which provides the physical connection to coupling 14. Each FE module 28 is able to recognize all targets of its respective type connected to coupling 14, and is able to register a device object for each target recognized.

SIML module 26 also defines an internal interface and provides common services to a file generation module 34, also herein termed SX module 34, which generates one or more substantially similar SX drivers, most preferably one SX driver, exemplified herein as an SX driver 37. SX driver 37 generates an interface object 36 which acts as an interface between operating system 32 and application 20. Interface object 36 may be any suitable file or pseudo-file or object wherein an indication of a connection and a command being transmitted via the connection may be entered. The functions of FE modules 28, HBAs 30, SX module 34, SX driver 37, and object 36 are described in more detail below.

Each volume 16 is configured within one of a plurality of targets 24. Targets 24 are also referred to herein as targets TA, TB, TC, . . . , TY, TZ, and collectively as targets T. Arrangement 10 typically comprises many targets 24, each of which may in turn comprise a multiplicity of volumes, as is provided for by SCSI-3 protocols known in the art. Such SCSI-3 protocols enable each volume to be addressed by using an ordered pair (target, volume number) that is a unique identifier for each volume. In prior art systems a device object is registered for each of these pairs in each host.

However, unlike registering a device object as SCSI-3 protocols known in the art do for each (target, volume number) pair (typically using one of the FE modules 28), preferred embodiments of the present invention use the mod-SCSI protocol to register a limited number of device objects 22 for targets 24 in host 12. Device objects 22 are also referred to herein as device objects DA, DB, DC, . . . , DY, DZ, and collectively as device objects D. Most preferably, one volume per target is registered, up to a total of 256 volumes. It will be understood that any convenient volume within a target may be registered. Hereinbelow, the volume having a volume number value 0 is assumed to be the volume registered. Thus, registered volumes are (TA, 0) , (TB, 0), . . . , (TZ, 0); the registered volumes are also referred to herein as volumes 17.

Each registered volume 17 has a corresponding device object D. The registration is made by FE modules 28, and all communication between SIML module 26 and the (target, volume number) pairs is made via one of the respective device objects D, as is described in more detail below, as well as via the appropriate FE module 28 and HBA 30. Hereinbelow, by way of example, device object DA is assumed to be registered for (TA, 0) in target TA, device object DB is assumed to be registered for (TB, 0) in target TB, . . . , and device object DZ is assumed to be registered for (TZ, 0) in target TZ.

Within each target 24, registered volume 17 comprises a device server 35 which communicates with its device object D. As described in more detail below, each device server 35 receives a modified SCSI command from its device object D, and conveys a recovered SCSI command to the volume within the target to which the modified SCSI command is directed. (Device server 35 typically communicates with its device object D via a volume driver and volume SCSI target mid-level module comprised in the volume 17 of the device server; for clarity, the volume driver and module are not shown in FIG. 2.)

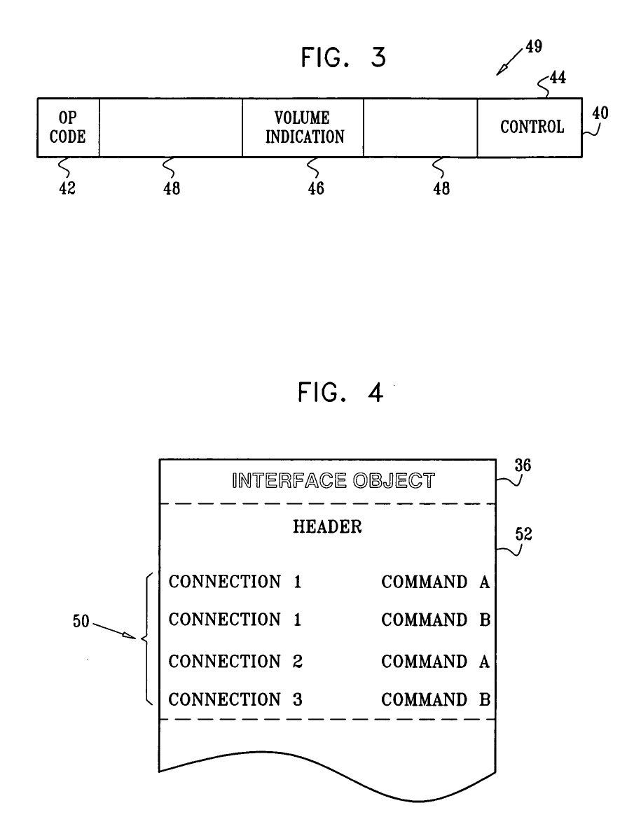

FIG. 3 is a schematic diagram illustrating a command structure 40, according to a preferred embodiment of the present invention. Fixed length commands according to SCSI-3 protocols known in the art are formed with lengths from between 6 bytes to 16 bytes. SCSI-3 protocols also define a variable length command. Both types of commands comprise an operation code field defining the command, and a control field.

Command structure 40 of the mod-SCSI protocol, also referred to herein as command 40 and as structure 40, comprises an operation code field 42 and a control field 44, as defined by the SCSI-3 protocols referred to above. Furthermore, in preferred embodiments of the present invention, structure 40 also comprises a volume indication field 46, preferably up to 2 bytes in length. Thus, unlike commands known in the art, command structure 40 encapsulates the volume indication within the command. The mod-SCSI protocol uses volume indication field 46 to direct the command having the field to the indicated volume, as described in more detail below.

Structure 40 also comprises other fields 48, as defined by the SCSI-3 protocols. Fields 48 include a logical block address (LBA) field 49, defined by the SCSI-3 protocol as an address on a logical unit (LU) or within a volume partition. It will be understood that LBA field 49 is used by SCSI-3 protocols as an address within a specific LU or volume partition to which a command is being transmitted, unlike the volume indication field 46 which is used by the mod-SCSI protocol to direct the command to the indicated volume.

FIG. 4 is a schematic representation of interface object 36 generated by SX module 34, according to a preferred embodiment of the present invention. Interface object 36 preferably comprises entries 50. Each entry 50 comprises an indication of a command being transmitted, and an indication of a connection via which the command is transmitted. The connection for any specific command comprises the device object D and registered volume 17 via which the command is transmitted. Thus, typically, the indication of the connection written to interface object 36 comprises the appropriate device object D and/or the registered volume 17.

Typically, interface object 36 is generally similar to an SG file generated by a Linux driver sg.o, in which case each entry 50 is most preferably provided as part of a header 52 written to the interface object, and the interface object is generated and maintained in substantially the same manner as an SG file. Alternatively, interface object 36 may be any other suitable file or pseudo-file or object wherein an indication of the connection and the command being transmitted via the connection may be entered. It will be appreciated that the indication of the connection and command provided by each entry 50 of interface object 36 may be in any other suitable form, such as assigning a parameter associated with a connection and/or flagging the connection. Hereinbelow, by way of example, the indication is assumed to be provided by writing to header 52.

For each entry 50, the connection defines the target to which the command is being written; the command defines the volume within the target in volume indication field 46 and the command in operation code 42.

It will be understood that the structure of entries 50 described herein is provided by way of example, and that other structures of such entries, comprising substantially the same information as entries 50, are included within the scope of the present invention. Such structures include, but are not limited to, using an ordered pair, such as (TA, volume number), to indicate a specific volume to which a command is directed.

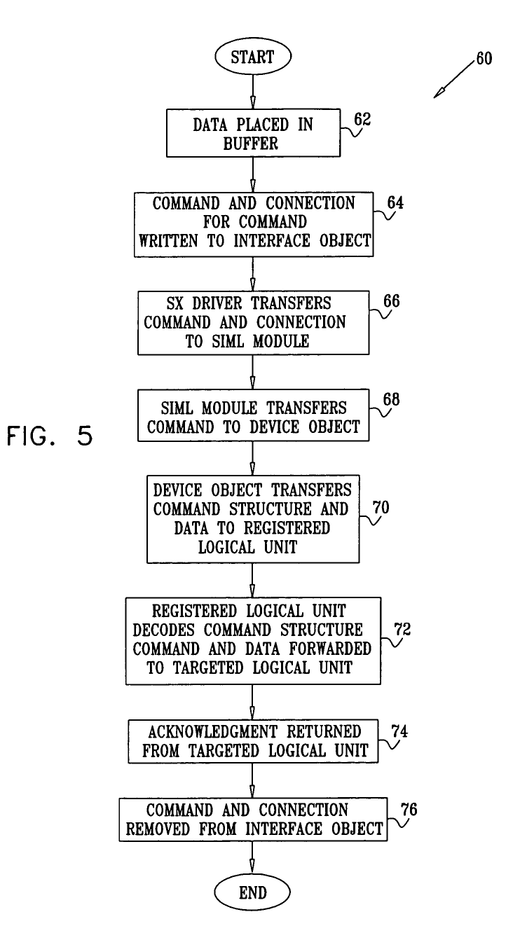

FIG. 5 is a flowchart 60 showing steps involved in performance of a command, according to a preferred embodiment of the present invention. The steps are followed when a command is sent from initiator 12 to a specific volume 16. In the description below, the steps are directed to writing data from application 23 to a pair (TA, Va), where pair (TA, Va) is assumed to represent a specific volume Va (of volumes 16) comprised in target TA. Those skilled in the art will be able to adapt the steps described herein, mutatis mutandis, to other commands for accessing data, such as reading data from a target.

In an initial step 62, application 23 places data to be written to (TA, Va) in an application buffer 21.

In a second step 64, application 23 generates a command 40 for writing the data, by writing to operation code field 42 the code for a write command, including in field 46 an indication of an address of volume Va. Volume address field 46 is set to correspond to the address of Va, in target TA. Other fields in structure 40, such as control field 44, LBA field 49, and those delineating a data transfer length, are set according to the SCSI-3 protocol.

Application 23 writes an indication of the command to interface object 36. Application 23 also writes an indication of the connection for command 40, i.e., the connection comprising device object DA and target TA, to interface object 36. The indications for the command and volume Va are written as described above with reference to FIG. 4, to header 52 of interface object 36.

SX driver 37 comprises a transfer function that enables it to convey command 40 to SIML module 26. In a third step 66, SX driver 37 transfers command 40 and the connection indication to SIML module 26, using the transfer function.

In a fourth step 68, SIML module 26 uses the command identification provided by interface object 36 to transfer command 40 to device object DA, and informs DA to convey command 40 to (TA, Va).

In a fifth step 70 DA transfers command structure 40, and the data stored in buffer 21, to the volume registered by driver DA, i.e., (TA, 0). It will be understood that transmission of the command may be dependent on device object DA opening a channel of communication to (TA, 0), for example, if coupling 14 comprises a bus, in which case device object DA obtains control of the bus before transmitting the command. Alternatively or additionally, at least part of such a channel may already exist, for example if coupling 14 comprises an Internet link.

In a sixth step 72, (TA, 0) receives structure 40 and the data. (TA, 0) decodes the structure, to determine from address field 46 the logical unit to which command structure 40 is addressed. (TA, 0) then forwards the command and the data to the appropriate volume, i.e. (TA, Va). (TA, Va) processes the command, i.e., writes the data to an address given by structure 40.

In a seventh step 74, (TA, Va) returns an acknowledgment of having stored the data to initiator 12. The acknowledgment is received by device object DA, and is read by SIML module 26. If the command from application 23 is a read command, rather than the write command considered herein, then in seventh step 74 data is transferred from (TA, Va).

In a final step 76, application 23 reads interface object 36 and removes the indication of the connection and the command from the interface object.

During operation of system 10, application 23 most preferably substantially continuously polls interface object 36. The polling enables the application to initiate commands, as well as to track the progress of the commands. It will be appreciated that such polling of the one interface object 36 is able to substantially completely replace the multiple actions, such as multiple file polling and/or multiple response to interrupts, of prior art SCSI environments.

It will be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for conveying a Small Computer System Interface (SCSI) command from a host to a logical volume, the method comprising:
incorporating an indication of an address of the logical volume in the SCSI command so as to generate a modified SCSI command;
conveying the modified SCSI command from the host to a target device;
receiving the modified SCSI command at the target device and recovering the address from the modified SCSI command; and
executing the SCSI command at the logical volume in response to the recovered address.

2. The method according to claim 1, wherein the logical volume comprises at least one of a volume partition and a logical unit.

3. The method according to claim 1, wherein the indication comprises the address of the logical volume.

4. The method according to claim 1, wherein the logical volume is comprised in a plurality of logical volumes, and wherein the target device is comprised in the plurality.

5. The method according to claim 1, wherein receiving the modified SCSI command at the target device comprises converting the modified SCSI command to the SCSI command and conveying the SCSI command to the logical volume in response to the recovered address.

6. The method according to claim 1, wherein the SCSI command comprises a logical block address (LBA) in the logical volume.

7. A method for accessing data, comprising:
generating in a host an interface object;
generating in the host a first plurality of device objects adapted to convey a data command from the host to a second plurality of logical volumes;
writing in the interface object from an application one or more indications of addresses of the logical volumes, the one or more indications comprising a target-indication of an address of a targeted logical volume;
designating one of the device objects to convey the data command to the targeted logical volume in response to the target-indication in the interface object; and
accessing the data in the targeted logical volume in response to the data command.

8. The method according to claim 7, wherein designating the one of the device objects comprises:
opening a connection between the one of the device objects and the targeted logical volume; and
conveying the data command via the connection.

9. The method according to claim 8, and comprising writing an indication of the connection in the interface object.

10. The method according to claim 7, wherein the interface object comprises at least one of a file and a pseudo-file.

11. The method according to claim 7, wherein accessing the data comprises one of reading the data from the targeted logical volume and writing the data to the targeted logical volume.

12. The method according to claim 7, and comprising:
performing an execution of the data command at the targeted volume; and
removing the target-indication from the interface object in response to the execution.

13. The method according to claim 7, wherein writing in the interface object comprises the application polling the interface object to perform the writing.

14. The method according to claim 13, wherein the application polling the interface object comprises the application removing the target-indication from the interface object in response to an execution of the data command at the targeted volume.

15. The method according to claim 7, wherein the host and the logical volumes operate according to a Small Computer System Interface (SCSI) protocol.

16. The method according to claim 15, wherein the data command comprises a SCSI command, the method further comprising:
incorporating the target-indication in the SCSI command so as to generate a modified SCSI command;
conveying the modified SCSI command from the host to a target device;
receiving the modified SCSI command at the target device and recovering the address from the modified SCSI command; and
executing the SCSI command at the targeted logical volume in response to the recovered address.

17. Apparatus for conveying a Small Computer System Interface (SCSI) command from a host to a logical volume, the apparatus comprising:
a processor which is adapted to:
incorporate an indication of an address of the logical volume in the SCSI command so as to generate a modified SCSI command, and
convey the modified SCSI command from the host; and
a target device which is adapted to:
receive the modified SCSI command at the target device and recover the address from the modified SCSI command, and
convey the SCSI command to the logical volume, for execution therein, in response to the recovered address.

18. The apparatus according to claim 17, wherein the logical volume comprises at least one of a volume partition and a logical unit.

19. The apparatus according to claim 17, wherein the indication comprises the address of the logical volume.

20. The apparatus according to claim 17, wherein the logical volume is comprised in a plurality of logical volumes, and wherein the target device is comprised in the plurality.

21. The apparatus according to claim 17, wherein the target device is adapted to convert the modified SCSI command to the SCSI command.

22. The apparatus according to claim 17, wherein the SCSI command comprises a logical block address (LBA) in the logical volume.

23. Apparatus for accessing data, comprising:
a targeted logical volume which is adapted to access the data in response to a data command; and
a host comprising:
an interface object;
a first plurality of device objects adapted to convey the data command from the host to a second plurality of logical volumes; and
a processor which is adapted to:
write in the interface object from an application one or more indications of addresses of the logical volumes, the one or more indications comprising a target-indication of an address of the targeted logical volume, and
designate one of the device objects to convey the data command to the targeted logical volume in response to the target-indication in the interface object.

24. The apparatus according to claim 23, wherein designating the one of the device objects comprises:
opening a connection between the one of the device objects and the targeted logical volume; and
conveying the data command via the connection.

25. The apparatus according to claim 24, wherein the processor is adapted to write an indication of the connection in the interface object.

26. The apparatus according to claim 23, wherein the interface object comprises at least one of a file and a pseudo-file.

27. The apparatus according to claim 23, wherein accessing the data comprises one of reading the data from the targeted logical volume and writing the data to the targeted logical volume.

28. The apparatus according to claim 23, wherein the targeted logical volume is adapted to perform an execution of the data command thereat, and wherein the processor is adapted to remove the target-indication from the interface object in response to the execution.

29. The apparatus according to claim 23, wherein writing in the interface object comprises the application polling the interface object to perform the writing.

30. The apparatus according to claim 29, wherein the application polling the interface object comprises the application removing the target-indication from the interface object in response to an execution of the data command at the targeted volume.

31. The apparatus according to claim 23, wherein the host and the logical volumes operate according to a Small Computer System Interface (SCSI) protocol.

32. The apparatus according to claim 31, wherein the data command comprises a SCSI command, wherein the processor is adapted to:
incorporate the target-indication in the SCSI command so as to generate a modified SCSI command,
convey the modified SCSI command from the host;
the apparatus further comprising:
a target device which is adapted to receive the modified SCSI command and recover the address from the modified SCSI command and convey the SCSI command to the targeted logical volume, for execution therein, in response to the recovered address.
